(19) United States
(12) Patent Application Publication
(10) Pub. No.: US 2012/0228941 A1
(43) Pub. Date: Sep. 13, 2012

(54) ELECTRIC POWER SUPPLY SYSTEM, MASTER CONTROL DEVICE, SYSTEM STABILIZATION SYSTEM, CONTROL METHOD FOR THE MASTER CONTROL DEVICE AND CONTROL PROGRAM FOR THE MASTER CONTROL DEVICE

(75) Inventor: Souichi SAKAI, Moriguchi-shi (JP)

(73) Assignee: SANYO Electric Co., Ltd., Moriguchi-shi (JP)

(21) Appl. No.: 13/425,139

(22) Filed: Mar. 20, 2012

Related U.S. Application Data
(63) Continuation of application No. PCT/JP2011/057344, filed on Mar. 25, 2011.

(30) Foreign Application Priority Data
Mar. 25, 2010 (JP) 2010-070673

(51) Int. Cl. H02J 7/34

(52) U.S. Cl. 307/66

(57) ABSTRACT

An electrical power supply system is managed by a master management system external to the supply system. The system includes a power generator generating electric power using renewable energy, a battery storing electric power generated by the power generator, and a power output device outputting power from the power generator or the battery. The system also includes a charge and discharge controller acquiring generated power data from the power generator, transmitting the generated power data to the master management system, computing a target output value for output from the power output device, and controlling charge and discharge of the battery such that the target output value is outputted from the power output device. The charge and discharge controller receives charge and discharge instruction signals from the master management device, and initiates or terminates the charge and discharge of the battery based on the charge and discharge instruction signals.

### CROSS-REFERENCE TO RELATED APPLICATIONS

This application is a continuation of International Application No. PCT/JP2011/057344, filed Mar. 25, 2011, which claims priority from Japanese Patent Application No. 2010-070673, filed Mar. 25, 2010, the entire contents of which are incorporated herein by reference.

### FIELD OF INDUSTRIAL USE

The present invention relates to an electric power supply system, a master control device, a system stabilization system, a control method for the master control device and a control program for the master control device

### PRIOR ART

In recent years, the number of instances where power generators (distributed power sources such as solar cells and the like) utilizing natural energy such as wind power or sunlight are connected to consumers (e.g. consumer homes and factories) in receipt of a supply of alternating power from an electricity substation has increased. These types of power generators are connected to the power grid subordinated to a substation, and power generated by the power generators is output to the power consuming devices side of the consumer location. The superfluous electric power, which is not consumed by the power consuming devices in the consumer location, is output to the power grid. The flow of this power towards the power grid from the consumer location is termed “counter-current flow”, and the power output from the consumer to the grid is termed “counter-current power”.

In this situation the power suppliers, such as the power companies and the like, have a duty to ensure the stable supply of electric power and need to maintain the stability of the frequency and voltage of the overall power grid, including the counter-current power components. For example, the power supply companies maintain the stability of the frequency of the overall electric power grid by a plurality of methods in correspondence with the size of the fluctuation period. Specifically, in general, in respect of a load component with a variable period of some tens of minutes, economic dispatching control (EDC) is performed to enable output sharing of the generated amount in the most economic manner. This EDC is controlled based on the daily load fluctuation expectation, and it is difficult to respond to the increases and decreases in the load fluctuation from minute to minute and second to second (the components of the fluctuation period which are less than some tens of minutes). In that instance, the power companies adjust the amount of power supplied to the power grid in correspondence with the minute fluctuations in the load, and perform plural controls in order to stabilize the frequency. Other than the EDC, these controls are called frequency controls, in particular, and the adjustments of the load fluctuation components not enabled by the adjustments of the EDC are enabled by these frequency controls.

More specifically, for the components with a fluctuation period of less than approximately 10 seconds, their absorption is enabled naturally by means of the endogenous control functions of the power grid itself Moreover, for the components with a fluctuation period of about 10 seconds to the order of several minutes, they can be dealt with by the governor-free operation of the generators in each generating station. Furthermore, for the components with a fluctuation period of the order of several minutes to tens of minutes, they can be dealt-with by load frequency control (LFC). In this load frequency control, the frequency control is performed by the adjustment of the generated power output of the generating station for LFC by means of a control signal from the central power supply command station of the power supplier.

However, the output of power generating devices utilizing natural energy may vary abruptly in correspondence with the weather and such like. This abrupt fluctuation in the power output of this type of power generator applies a gross adverse impact on the degree of stability of the frequency of the power grid they are connected to. This adverse impact becomes more pronounced as the number of consumers with generators using natural energy increases. As a result, in the event that the number of consumers with electricity generators utilizing natural energy increases even further henceforth, there will be a need arising for sustenance of the stability of the power grid by the control of the abrupt fluctuation in the output of the generators.

In relation to that, there have been proposals, conventionally, to provide power generation systems with storage devices to enable the storage of electricity resulting from the power output generated by these types of electricity generators, in addition to the generators utilizing natural energy, in order to control the abrupt fluctuation in the power output of these distributed type generators. Such a power generation system was disclosed, for example, in Japanese laid-open patent publication No. 2001-5543.

In the Japanese laid-open published patent specification 2001-5543 described above, there is the disclosure of a power system provided with solar cells, and invertors which are connected to both the solar cells and the power grid, and a battery which is connected to a bus which is also connected to the inverter and the solar cells. In this power generation system, by performing electrical charging and discharging of a battery in tandem with the fluctuations in the generated power (output) of the solar cell, the fluctuation in the power output from the invertor can be suppressed. Because this enables the suppression of the fluctuations in the power output to the power grid, the suppression of the adverse effects on the frequency of the power grid is enabled.

### PRIOR ART REFERENCES

Patent Reference #1: Japanese laid-open published patent specification 2001-5543.

### OUTLINE OF THE INVENTION

### Problems to be Solved by the Invention

However, in Japanese laid-open published patent specification 2001-5543, because charge and discharge of the battery is performed on every occasion where there is fluctuation in the generated power output of the (distributed type power source) power generator, the number of instances of charge and discharge are great, and as a result, there is the problem that the lifetime of the battery is decreased.

This invention was conceived of to resolve the type of problems described above, and one object of this invention is the provision of a system stabilization system which enables a contrivance at lengthening the lifetime of the battery while suppressing the effects on the power grid caused by the fluctuations in the power generated by the distributed type power sources, and the provision of a power generation system connected to a networked system and a control device for the power generation systems connected to the networked system.

### SUMMARY OF THE INVENTION

The invention provides an electrical power supply system managed by a master management system external to the supply system. The supply system includes a power generator configured to generate electric power using renewable energy, a battery configured to store electric power generated by the power generator, and a power output device configured to output power from at least one of the power generator and the battery. The supply system also includes a charge and discharge controller configured to acquire generated power data from the power generator, to transmit the generated power data to the master management system, to compute a target output value for output from the power output device based on the generated power output data, to control charge and discharge of the battery such that the target output value is outputted from the power output device. The charge and discharge controller is also configured to receive charge and discharge instruction signals from the master management device, and to initiate or terminate the charge and discharge of the battery based on the charge and discharge instruction signals.

The invention also provides a master control device which controls plural electrical power supply systems external to the control device. The master control device includes a generated power data acquisition unit configured to acquire generated power data from each of the plural power supply systems, a power computation unit configured to compute a total power output by summing the generated power data from the plural power supply systems, a charge and discharge controller configured to determine whether the total power output exceeds a predetermined threshold value, to transmit charge and discharge instruction signals in accordance with determination results to the power supply systems.

The invention provides a method of controlling a master control device managing plural power supply systems external to the control device. The method includes acquiring generated power output data from the plural power supply systems, computing a total power output by summing the power output data from the plural power supply systems, determining whether the total power output exceeds a predetermined threshold value, transmitting charge and discharge instruction signals in accordance with the determination to the power supply systems.

The invention also provides a computer-readable recording medium which records a control programs for causing one or more computers to perform the steps comprising acquiring generated power output data from plural power supply systems, computing a total power output by summing the power output data from the plural power systems, determining whether the total power output exceeds a predetermined threshold value, and transmitting charge and discharge instruction signals in accordance with the determination to the power supply systems.

The invention further provides an electrical power supply system managed by a master management system external to the supply system. The supply system includes a power generator configured to generate electric power using renewable energy, a battery configured to store electric power generated by the power generator, and a detector configured to detect power output data which are amounts of power output flowing on a power line connecting the power generator and a power grid. The supply system also includes a charge and discharge controller configured to communicate with the master management system, to compute a target output value for output to the power grid based on the detected power output data, to control charging and discharging of the battery so as to output the target output value to the power grid from at least one of the power generator and the battery. The charge and discharge controller is further configured to receive charge and discharge instruction signals from the master management device and to initiate or terminate charge and discharge of the battery based on the charge and discharge instruction signals.

### BENEFITS OF THE PRESENT INVENTION

By means of the present invention, a contrivance at lengthening the lifetime of the battery is enabled while suppressing the effects on the power grid caused by the fluctuations in the generated power output of distributed type power sources.

### BRIEF DESCRIPTION OF THE DRAWINGS

FIG. 1 is a schematic view showing the configuration of the stabilization system of embodiment 1 of the present invention.

FIG. 2 is a block diagram showing the configuration of the power generation systems employing the stabilization system of embodiment 1 of the present invention.

FIG. 3 is a drawing to explain the relationship between the intensity of the load fluctuation output to the power grid and the fluctuation period.

FIG. 4 is a flow chart in order to explain the flow of the control of the initiation and termination of the smoothing control of the power generation system of the stabilization system of the first embodiment of the present invention.

FIG. 5 is a flow chart in order to explain the flow of the control of the initiation and termination of the smoothing control of the centralized management device of the stabilization system of the first embodiment of the present invention.

FIG. 6 is a diagram in order to explain the sampling period in the charge and discharge control.

FIG. 7 is a drawing showing the location relationship of some of the major cities in the southern part of Hyogo Prefecture, Japan.

FIG. 8 is a drawing showing the fluctuation in the sunlight hours in the cities lined-up in the East-West direction in the region shown in FIG. 7.

FIG. 9 is a drawing showing the fluctuation in the sunlight hours in the cities lined-up in the North-South direction in the region shown in FIG. 7.

FIG. 10 is a drawing in order to explain the settings of the regional model in a simulation to prove the effectiveness of the present invention.

FIG. 11 is a graph showing the trends in the generated power output for each region shown in FIG. 10.

FIG. 12 is a graph showing the trends in the total power output of the generated power output for each region shown in FIG. 10.

FIG. 13 is a block diagram showing the configuration of the power generation systems employing the stabilization system of embodiment 2 of the present invention.

### BEST METHOD OF EMBODYING THE INVENTION

Hereafter the embodiments of the present invention are explained based on the figures.

### Embodiment 1

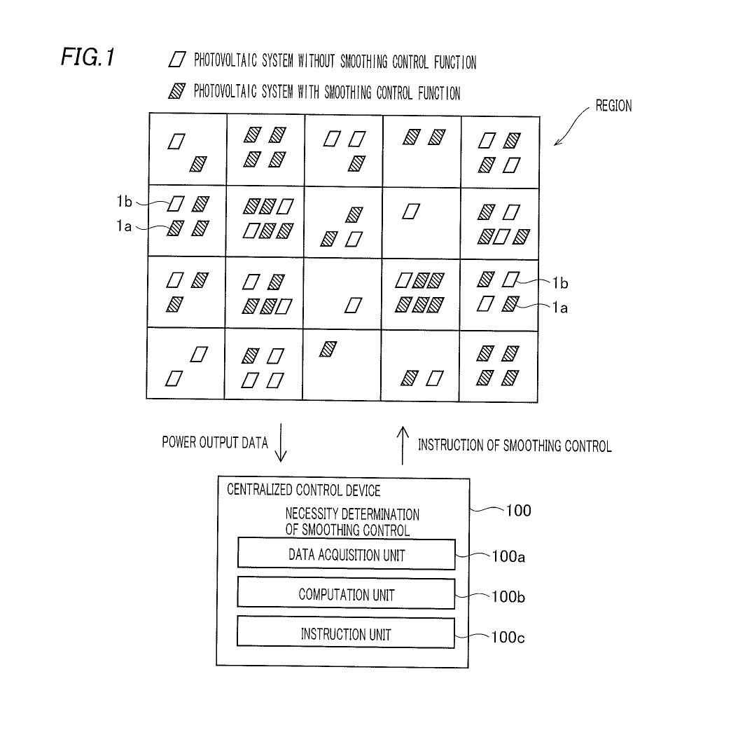

Firstly, the configuration of the stabilization system of the first embodiment of the invention is explained while referring to FIG. 1˜3.

As shown in FIG. 1, the stabilization system provides the plural photovoltaic (PV) systems 1a and 1b disposed in a specific region, and the centralized control device 100 communicating with the plural PV systems 1a and 1b. Now the specific region means, for example, the management region of a power company.

(★ [symbol] )

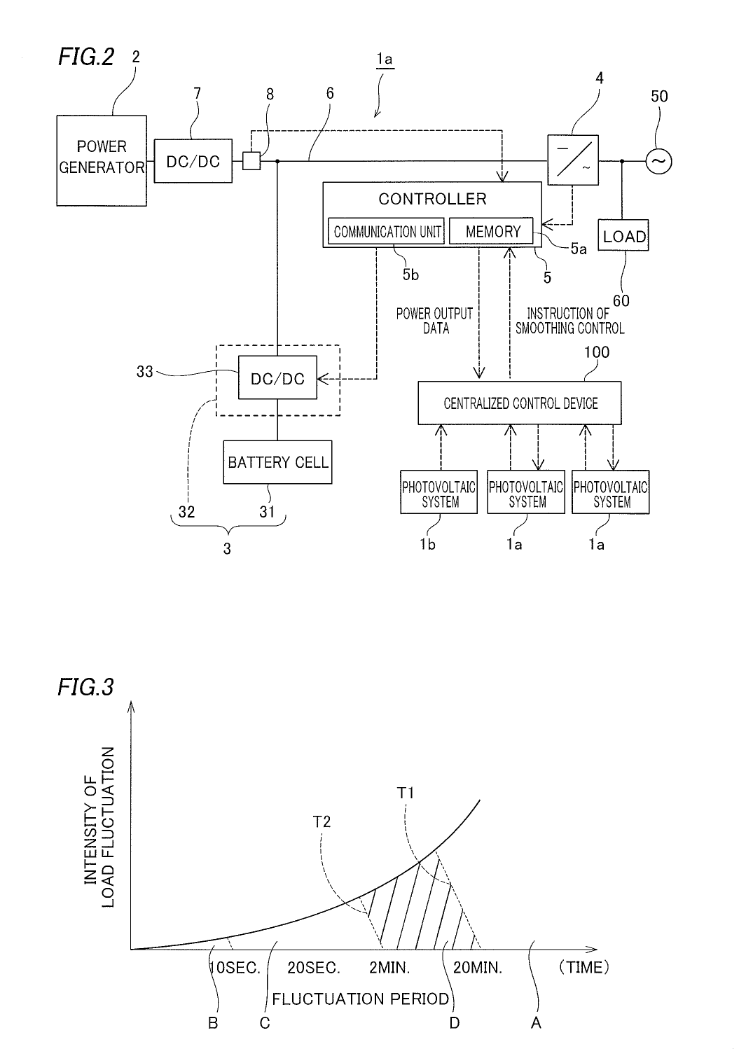

The PV system 1a, as shown in FIG. 2, provides the power generator 2. It is also connected to the power grid 50, and so counter current flows as a result of the power generated by the power generator 2 to the power grid 50. Moreover, the PV system 1a has battery 3, and so the fluctuations of the counter current flow of power output to power grid 50 are smoothed (The smoothing control function) by the charge and discharge control of the battery 3. The PV system 1b is, not shown in the figures but, other than lacking the battery 3, has the configuration of the PV system 1a such that it lack a smoothing control function.

The centralized control device 100 provides the data acquisition unit 100a, and the computation unit 100b, and the instruction unit 100c. The data acquisition unit 100a acquires power output data from each of plural PV systems 1a and 1b in a specific area. The computation unit 100b totals the plural power output data acquired by the data acquisition unit 100a and computes the total power output. The instruction unit 100c makes a determination as to whether the total power output, computed by the computation unit 100b, exceeds a specific threshold value or not, and transmits charge and discharge control signals in correspondence with the determination result via the communications unit 5b (see FIG. 2) to the PV system 1a.

By means of the configuration described above, the centralized control device 100 detects the fluctuation amount in the total power output of PV systems 1a and 1b in a specific area and causes the smoothing control of the power output of PV systems 1a in a specific area to be initiated or terminated. In the event that the power output of the PV systems 1a and 1b in a specific area counter current flows to the power grid 50, and when the fluctuations in the power output fluctuate greatly in tandem with the fluctuations in sunlight, there is the possibility that the power grid 50 could become unstable. Because of this, in the current embodiment, the centralized control devices 100 manages the counter current flows from PV systems 1a and 1b to the power grid 50 for each specific area.

Hereafter, the control of the centralized control device 100 is explained in detail.

The PV systems 1a and 1b acquire the power output data of the power generators 2 at each of specific detection time interval (for example, less than 30 seconds). The data acquisition unit 100a successively acquires the power output data from the PV systems 1a and 1b in a specific area at each detection time interval. The computation unit 100b computes the total power output for each detection time interval and computes the fluctuation amount in the total power output by computing the difference between two consecutive total power output data computed at each detection time interval.

The instruction unit 100c determines whether the fluctuation amount in the total power output is above a specific fluctuation amount or not (Hereafter referred to as ‘the control initiating fluctuation amount’). When a determination is reached that the fluctuation amount in the total power output is greater than the control initiating fluctuation amount, the instruction unit 100c makes each PV system 1a perform smoothing control The control initiating fluctuation amount, for example, can be set at 5% of the total rated power output value (hereafter referred to as ‘the total rated power output’) of the power generators 2 of the PV systems which transmit power output data to the centralized control device 100. Now in relation to the specific numerical value cited above (5% of the total value of the rated power output), when the detection time interval is varied, there is a need to set the control initiating fluctuation amount anew in correspondence with that detection time interval.

Moreover, after the instruction unit 100c makes the PV system 1a initiate the smoothing control, in the event that the size of the total power output is less than a specific value in continuity for a specific period (hereafter referred to as ‘the control termination determination period’), the instruction unit 100c makes the PV system 1a terminate the smoothing control. Moreover, when the total power output is less than the specific value in continuity for less than the control termination determination period, the instruction unit 100c makes the PV system 1a continue the smoothing control. The specific value, for example, is 5% of the total rated power output. Furthermore, the control termination determination period is a period which corresponds to a fluctuation period which the load frequency control (LFC) can deal with. In the first embodiment this is 20 minutes. In other words, after the instruction unit 100c instructs the initiation of smoothing control of the PV system 1a, when the total power output is less than 5% of the total rated power output in continuity for 20 minutes, the termination of smoothing control is instructed.

Next, the configuration of the PV system 1a is explained.

The PV system 1a provides the power generator 2 comprised of solar cells, and the battery 3 which is capable of storing the power generated by power generator 2, and the supply section 4 including an inverter which outputs power generated by power generator 2 and power output stored by battery 3 to the power grid 50, and the charge and discharge controller 5 which controls the charge and discharge of the battery 3. Moreover, there is a load 60 connected to the alternating current bus 6 connected to the power grid 50 and to the supply section 4. Now, the power generator 2 need only utilize power generators utilizing renewable energy and, for example, may employ wind power generators.

The DC-DC converter 7 is connected in series on the bus 6 connecting the power generator 2 and the supply section 4. The DC-DC converter 7 converts the direct current voltage of the power generated by the power generator 2 to a fixed direct current voltage (In embodiment 1, approximately 260 V) and outputs to the supply section 4 side. Moreover, the DC-DC converter 7 has a so-called a maximum power point tracking (MPPT) control function. The MPPT function is a function whereby the operating voltage of the power generator 2 is automatically adjusted to maximize the power generated by the power generator 2. A diode is provided (not shown in the figures) between the power generator 2 and the DC-DC converter 7 so as to prevent the reverse flow of the current to the power generator 2.

The battery 3 includes the battery cell 31 connected in parallel with the bus 6, and the charge and discharge means 32 which performs the charge and discharge of the battery cell 31. As the battery cell 31, a high charge and discharge efficiency ratio rechargeable battery with low natural discharge (e.g. a lithium ion battery cell, a Ni-MH battery cell and the like) are employed. Moreover, the voltage of the battery cell 31 is approximately 48 V.

The charge and discharge means 32 has a DC-DC converter 33, and the bus 6 and the battery cell 31 are connected via the DC-DC converter 33. When charging, the DC-DC converter 33 supplies electrical power from the bus 6 side to the battery cell 31 side by reducing the voltage of the bus 6 to a voltage suitable for charging the battery cell 31. Moreover, when discharging, the DC-DC converter 33 discharges the electrical power from the battery cell 31 side to the bus 6 side by raising the voltage from the voltage of the battery cell 31 to the vicinity of the voltage of the bus 6 side.

The electrical controller 5 performs the charge and discharge control of battery cell 31 by controlling the DC-DC convertor 33, and smoothes the value of the power output to the power grid 50. In order to smooth the power output value to the power grid 50 irrespective of the power output of the power generator 2, the controller 5 sets a target output value to the power grid 50. The controller 5 controls the charge and discharge of the battery cell 31 so that the power output to the power grid 50 becomes the target output value. In other words, in the event that the power output by the power generator 2 is greater than the target output value, the controller 5 not only controls the DC-DC converter 33 to charge the battery cell 31 with the excess electrical power, in the event that the power output by the power generator 2 is less than the target output value, the controller 5 controls the DC-DC converter 33 to discharge the battery cell 31 to make up for the shortfall in the electrical power.

Moreover, the controller 5 acquires the power output data of the power generator 2 from the detector 8 provided on the output side of DC-DC converter 7. The detector 8 detects the power output of the power generator 2 and transmits the power output data to the controller 5. The controller 5 acquires the power output data from the detector 8 at each of specific detection time intervals (e.g. less than 30 seconds). Here, the power output data is acquired every 30 seconds in the first embodiment.

Moreover, the controller 5 provides memory 5a, and the communications unit 5b in order to communicate with the centralized control device 100. Every time power output data is acquired (at each detection time interval), the controller 5 transmits it to the centralized control device 100. Now if the detection time interval of the power output data is too long or too short, the fluctuation in the power output cannot be detected accurately, it is set at an appropriate value in consideration of the fluctuation period of the power output of the power generator 2. In this embodiment, the detection time interval is set to be shorter than the lower limit period of the fluctuation period which the load frequency control (LFC) can deal with.

The controller 5 recognizes the difference between the actual power output by the supply section 4 to the power grid 50 and target output value, by acquiring the output power of the supply section 4. By this means, the controller 5 controls the charging and discharging by the charge and discharge means 32 such that the power output from the supply section 4 becomes that of the target output value.

Next, the charge and discharge control method of the battery cell 31 by the controller 5 is explained. As described above, the controller 5 controls the charge and discharge of the battery cell 31 so that the total power output by the power generator 2 and the amount charged or discharged of the battery cell 31 becomes the target output value. The target output value is computed using the moving average method. The moving average method is a computation method for the target output value for a point in time, wherein the average value for the power output by the power generator 2 in a period from the point in time back to the past is computed. The prior power output data was successively recorded in memory 5a. Hereafter, the periods in order to acquire the power output data used in the computation of the target output value are called the sampling period. As a specific example of the value for the sampling period, for example, with power grids with ‘Intensity of load fluctuation-fluctuation period’ characteristics as shown in FIG. 3, they are periods of greater than 10 minutes and less than 30 minutes, and in the first embodiment, the sampling period is set at approximately 20 minutes. In this situation, because the controller 5 acquires the power output data approximately every 30 seconds, the target output value is computed from the average value of 40 power output data samples in the last 20 minute interval.

Here, in the first embodiment, the controller 5 does not perform smoothing control all the time, the configuration is such that the charge and discharge control is only performed when instructions are received from the centralized control device 100 to initiate smoothing control. Moreover, when the controller 5 performs smoothing control, the configuration is such that the charge and discharge control is terminated when instructions are received from the centralized control device 100 to terminate smoothing control.

Next, an explanation is provided on the fluctuation period range performed mainly the fluctuation suppression by the charge and discharge control by the controller 5. As shown in FIG. 3, the control method which enabled a response to the fluctuation period is different and the load fluctuation periods which load frequency control (LFC) can deal with are shown in domain D (The domain shown shaded). Moreover, the load fluctuation periods which EDC can deal with are shown in domain A. Now domain B is a domain in which the load fluctuation can be absorbed naturally by the endogenous controls of the power grid 50. Furthermore, domain C is a domain which can be dealt with by the governor free operation of each of the power generators of the generating stations. Here, the border line between domain D and domain A corresponds to the upper limit period T1 of the fluctuation periods of the loads which can be dealt with by the load frequency control and the border line between domain C and domain D corresponds to the lower limit period T2 of the fluctuation periods of the loads which can be dealt with by the load frequency control. This upper limit period T1 and the lower limit period T2, are not characteristic periods, and can be understood to be numerical values fluctuating with the intensity of the load fluctuations. In addition, the time of the fluctuation period shown in the figures will vary with the architecture of the power network. For example, the values of the lower limit period T2 and the upper limit period T1 will vary as a result of the effects of the so called “run-in” effect on the power grid side. Furthermore, the size of the run-in effect will vary with the degree of installed base of PV systems and their regional distribution. In this embodiment, looking at the load fluctuation which have the fluctuation periods are included in the range of domain D (the domain which can be dealt with by LFC) but which is the range where EDC, the governor free operation or the endogenous control of the power grid 50 cannot deal with, and the objective is enable to suppress the load fluctuation.

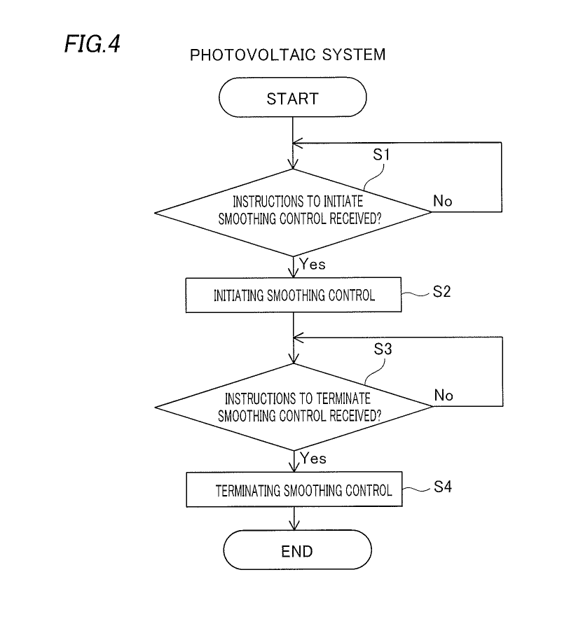

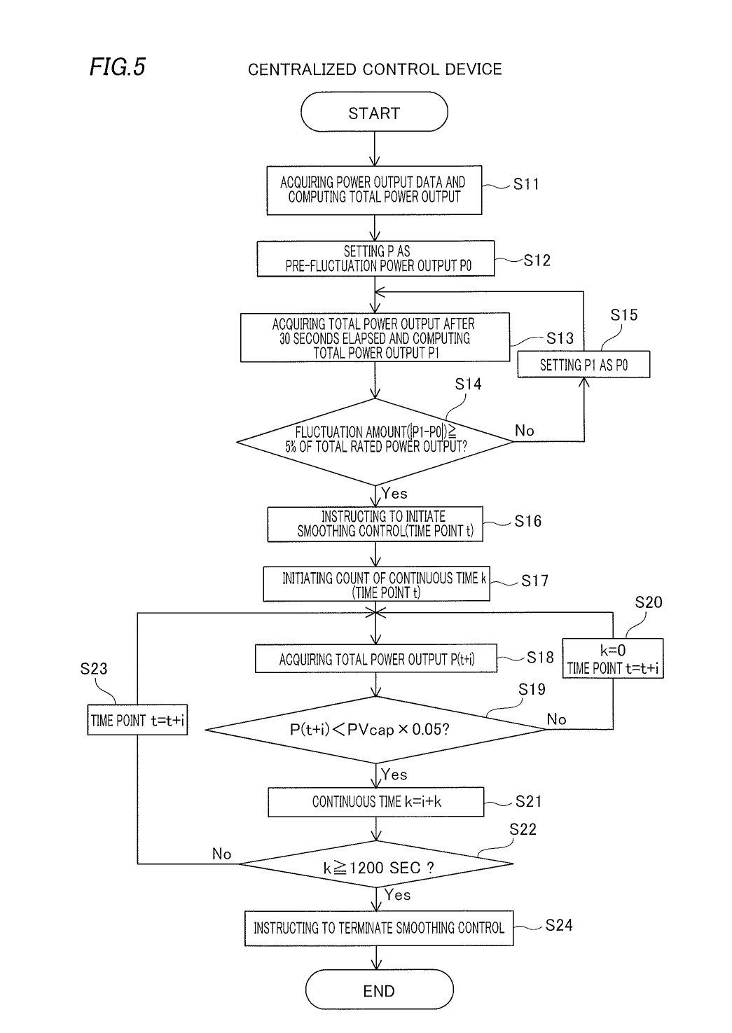

Next, an explanation is provided of the control flow of the PV system 1 of the stabilization system of embodiment 1 while referring to FIG. 4.

Where smoothing is being performed or not, the controller 5 successively transmits the power output data, acquired every detection time interval (30 seconds) from the detector 8 to the centralized control device 100. Moreover, other PV systems 1a and 1b in the area also transmit the power output data to the centralized control device 100 in the same manner. The centralized control device 100 makes a determination as to whether smoothing control is required or not based on the power output data received from the PV systems 1a and 1b in the area.

Firstly, in step S1, the controller 5 makes a determination as to whether instructions have been received from the centralized control device 100 to initiate smoothing control. If there were no instructions to initiate, the controller 5 repeats this determination. If instructions were received to initiate, in step S2, the controller 5 initiates smoothing control. In other words, the controller 5 not only computes the target output value based on its own past power output data by power generator 2, using the moving averages method, and causes the target output value to be output from supply section 4, by charging/discharging of the battery cell 31 the difference between the actual power output and the target output value.

Moreover, in performing smoothing control, in step S3, the controller 5 determines where an instruction has been received from the centralized control device 100 to terminate smoothing control or not. In the event that there was no instruction to terminate, the controller 5 repeats this determination. In the event that there were instructions to terminate, the controller 5 terminates smoothing control in step S4.

Next, referring to FIG. 5, an explanation is provided of the control flow of the centralized control device 100 of the stabilization system of embodiment 1.

Then, in step S11, the centralized control device 100 not only acquires the power output data of each of the power generators 2 at a specific point in time from the PV systems 1a and 1b in the area, and by totaling those power output data, a total power output P is computed. Then in step S12, the centralized control device 100 sets the acquired total power output P as the pre-fluctuation total power output P0. Next, in step S13, the centralized control device 100, not only again acquires the power output data of every power generator 2 after 30 seconds (The detection time interval) from when the total power output P0 was computed, and the total power output thereof is set as P1.

Thereafter in step S14, the centralized control device 100 makes a determination as to whether the fluctuation amount in the total power output (|P1−P0|) is greater than the control initiating fluctuation amount or not (5% of the rated power output of the power generator 2). If the fluctuation amount in the total power output is not greater than the control initiating fluctuation amount, the centralized control device 100 sets P1 as P0 in step S15 and acquires the value of P1 to monitor the fluctuation in the total power output in Step S13.

When the fluctuation amount in the total power output is greater than the control initiating fluctuation amount, in Step S16, the centralized control device 100 reaches a determination that the initiation of smoothing control is required, and instructs every PV system 1a to initiate the smoothing control. In embodiment 1, instructions to perform smoothing of every PV system 1a in the area are carried out. In the following explanation, the point in time where the charge and discharge instruction is performed is designated time t.

Moreover, simultaneous with the instruction to initiate the smoothing control (time point t), in step S17, the centralized control device 100 initiates a count of the continuous time k where the total power output was less than 5% of the total rated power output. Then in step S18, when time t+i is reached (i=detection time interval (30 seconds)), the centralized control device 100 acquires the total power output P (t+i) at the point in time t+i. Moreover, in step S19, the centralized control device 100 reaches a determination as to whether the total power output P (t+i) at time point t+i is less than 5% of the total rated power output PVcap (whether P(t+i)<PVcap×0.05 is satisfied or not).

In the event that P(t+i)<PVcap×0.05 is not satisfied, the centralized control device 100 sets the continuous time k to 0 in Step S20, and after setting t=t+i, returns to step S18. Moreover, in the event that P(t+i)<PVcap×0.05 is satisfied, the centralized control device 100 sets the continuous time k to k+i in Step S21. Thereafter in step S22, the centralized control device 100 makes a determination as to whether the continuous time k is greater than 1200 seconds or not (When the control terminating determination period is 20 minutes). If the continuous time k is less than 1200 seconds, the centralized control device 100, after setting time t=t+i in step S23, returns to step S18, and repeats steps S18˜S23 until the continuous time k becomes greater than 1200 seconds. When the continuous time k is greater than 1200 seconds, in step S24, the centralized control device 100 reaches a determination that termination of the smoothing control is required, and instructs the PV system 1a terminate the smoothing control.

The stabilization system of embodiment 1 enables the following benefits by the configuration described above.

The stabilization system provides the centralized control device 100 which can communicate with plural PV systems 1a and 1b disposed in a specific area. Based on the power output data of the plural PV systems 1a and 1b in the area, the centralized control device 100 makes a determination as to whether to perform smoothing of the power output of the plural PV systems 1a in the area. The PV systems 1a in the area perform smoothing of the power output to the power grid 50 based on the determination result of the centralized control device 100. By this means, when the centralized control device 100 determines that smoothing of the power output in the entire area is not required, based on the power output data of the plural PV systems 1a and 1b in the area, even if smoothing is required at individual PV systems 1a, smoothing of the plural PV systems 1a in the area is not performed. In other words, when the area is viewed in its entirety, where there is suppression of fluctuations in the output to the power grid 50 by the so called run-in effect, even when smoothing is required at individual PV systems 1a, when the region is viewed in its entirety, smoothing is not actually required. As a result, the number of charge and discharge events of the individual PV systems 1a can be reduced, and a contrivance at lengthening the lifetime of the battery 3 is enabled. Now, the run-in effect means that, for example, when solar power generators are employed as distributed power sources, by utilizing the fact that the distributed power sources are in mutually separated locations and the timing of the impact of a cloud (The timing of the fluctuation in the power output) is therefore different, and by means of the mutual cancellation effect of the fluctuations in the power output between the individual distributed power sources, viewed as an entire region, there is the effect that the fluctuations in the power output are seen to be moderate.

Moreover, the centralized control device 100 makes a determination as to whether to perform smoothing of the power output of the plural PV systems 1a in the area based on the fluctuation amount in the total power output. By this means, the centralized control device 100 can make a determination as to whether to perform smoothing of the power output of the plural PV systems 1a in the area based on the fluctuation amount of the power output of the power generators 2 in the entire area. This fluctuation amount for the totality of the region, unlike the fluctuation amount of the power output of the individual PV systems 1a, because it is an fluctuation amount whose fluctuation is suppressed by the run-in effect, by determining whether smoothing is required or not based on the fluctuation amount for the whole area, the suppression of the performance of smoothing control which is otherwise unnecessary is enabled. By this means, because the number of instances of the charging and discharging of the battery 3 and the amount of the charge and discharge can be reduced, a contrivance at lengthening the lifetime of the battery 3 is enabled.

Furthermore, in the event that the fluctuation amount of the total power output is greater than the control initiating fluctuation amount, the centralized control device 100 determines that smoothing should be performed on the power output of the PV systems in the area. In this manner, when the adverse effects on the power grid 50 would be low, and the fluctuation amount of the total power output is low, the suppression of the performance of smoothing control is enabled. By this means, because the number of instances of the charging and discharging of the battery 3 and the amount of the charge and discharge can be reduced, a contrivance at lengthening the lifetime of the battery 3 is enabled.

Moreover, the detection time interval is less than the lower limit period of the fluctuation periods which the load frequency control can deal with. By this means, and by detection of the fluctuations in the power output based on the power output acquired in this type of detection time interval, fluctuations in the generated power output which have fluctuation periods which the load frequency control can deal with can be detected easily. By this means, charge and discharge control is enabled while reducing the fluctuation components of the fluctuation periods which the load frequency control can deal with.

Furthermore, the sampling periods are period which are above the lower limit period of the fluctuation periods which the load frequency control can deal with. By controlling charge and discharge such that the target output value is computed in this type of sampling period range, in particular, enables a reduction in the components of the fluctuation periods which the load frequency control can deal with. By this means, the effective suppression of adverse effects on the power grid 50 is enabled in the range of fluctuation periods which the load frequency control can deal with.

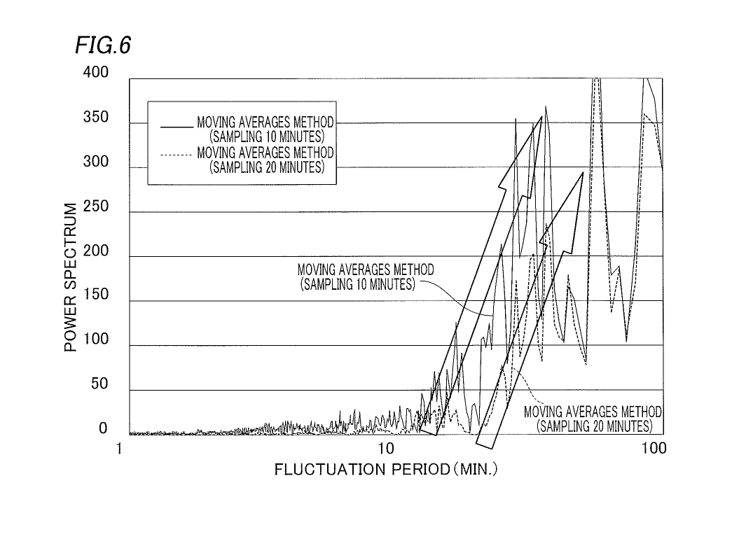

Next, the sampling periods of the moving average method were investigated. FIG. 6 shows the results of the FFT analysis of the power output data when the sampling period which is the acquisition period of the power output data was 10 minutes, and the results of the FFT analysis of power output data when the sampling period was 20 minutes.

As shown in FIG. 6, when the sampling period was 10 minutes, while the fluctuations in respect of a range of up to 10 minutes of a fluctuation period could be suppressed, the fluctuations in a range of fluctuation periods which were greater than 10 minutes were not suppressed well. Moreover, when the sampling period was 20 minutes, while the fluctuations in respect of a range of up to 20 minutes of a fluctuation period could be suppressed, the fluctuations in a range of fluctuation periods which were greater than 20 minutes was not suppressed well. Therefore, it can be understood that there is a good mutual relationship between the size of the sampling period, and the fluctuation period which can be suppressed by the charge and discharge control. For this reason, it can be said that by setting the sampling period, the range of the fluctuation period which can be controlled effectively changes. In that respect, in order to suppress parts of the fluctuation period which can be addressed by the load frequency control which is the main focus of this system, it can be appreciated that in order that sampling periods which are greater than the fluctuation period corresponding to what the load frequency control can deal be set, in particular, it is preferable that they be set from the vicinity of the latter half of T1˜T2 (The vicinity of longer periods) to periods with a range greater than T1. For example, in the example in FIG. 3, by utilizing a sampling period of greater than 20 minutes, it can be appreciated that suppression of most of the fluctuation periods corresponding to the load frequency control is enabled. However, when the sampling period is made longer, there is a tendency that the required battery capacity grows large, and it is preferable to select a length of sampling period which is not much longer than T1.

Next, an explanation is provided of the results of a simulation to investigate the effectiveness of this invention.

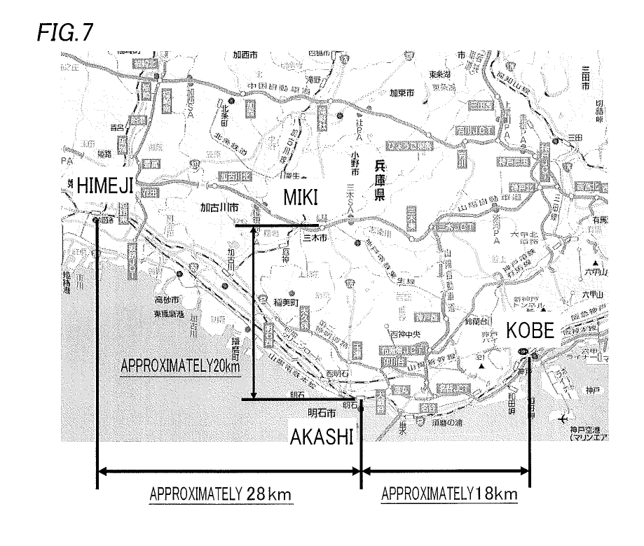

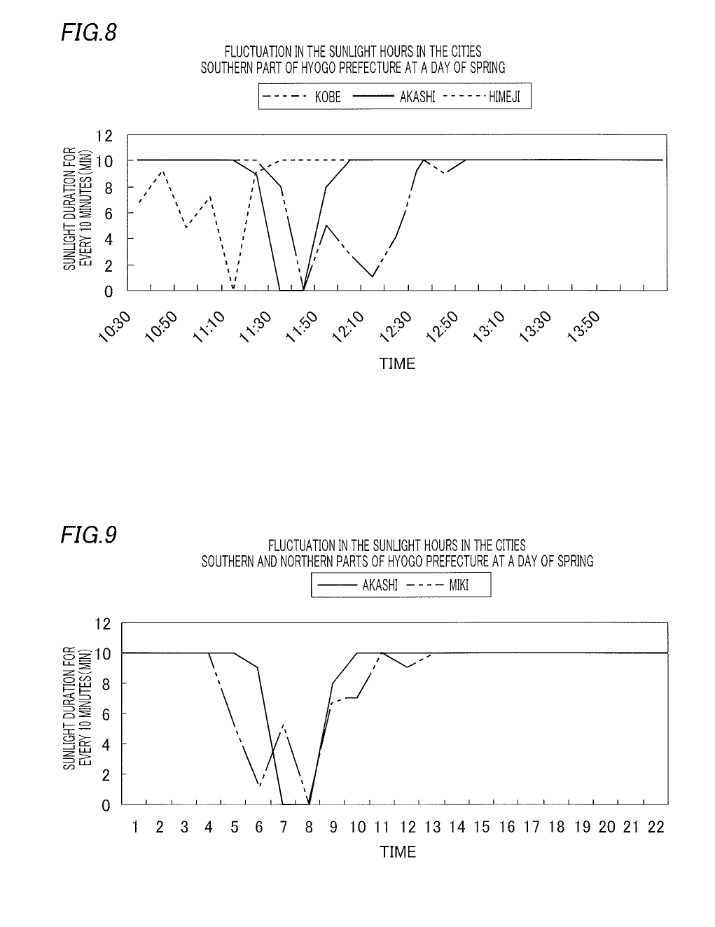

Firstly, an evaluation was performed of the run-in effect. FIG. 7 is a drawing showing the location relationship of some of the major cities in the southern part of Hyogo Prefecture, Japan. FIG. 8 and FIG. 9 are drawings showing the fluctuation in the sunlight hours in the cities in the region shown in FIG. 7. The vertical axis in FIG. 8 and FIG. 9 shows the sunlight duration for every 10 minutes period (while the sun is up). Now, the constant for sunlight is when there is at least 120 watts of direct sunlight incident per square meter. The data of FIG. 8 and FIG. 9 is based on data from the meteorological agency.

As shown in FIG. 7, Kobe, Akashi and Himeji are located in the East-West direction, while Miki is located to the north of Akashi. As shown in FIG. 8, when the cities located in the East-West direction (Kobe, Akashi and Himeji) are compared, the time band when the duration of sunlight falls is earliest in the order of Himeji, Akashi and Kobe. This is thought to be because the clouds move from West to East. In Japan, because of the effects of westerly winds, clouds tend to move from west to east. On the other hand, as shown in FIG. 9, when the cities located in the North-South direction are compared, (Akashi and Miki), the time band when the duration of sunlight falls changes little. Therefore, clouds move in the West-East direction, while it can be appreciated that there is little North-South movement of clouds. Because of this, when considering the run-in effect, when the PV systems transmitting power output data to the centralized control device 100 are located in an East-West direction distribution, it can be appreciated that the run-in effect will be great.

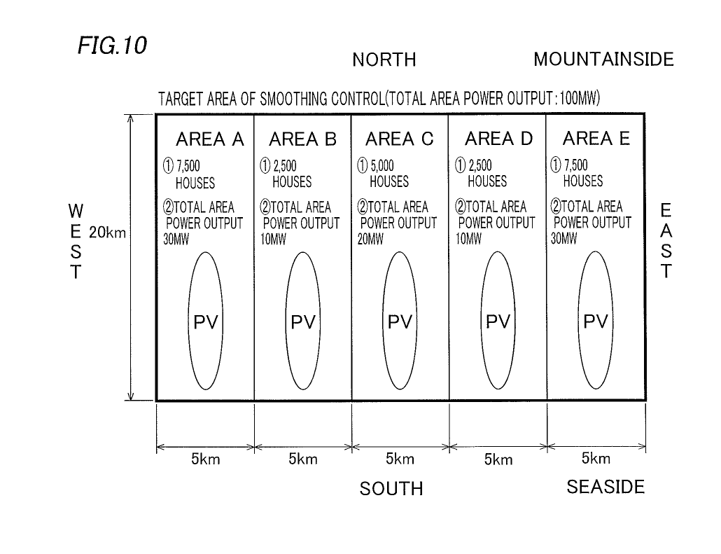

The area model shown in FIG. 10 was designed based on the result described above. In other words, using an area with a 5 km East-West extension and 20 km North-South extension, the East-West direction is divided into five areas A, B, C, D and E, and houses with PV systems (PV systems 1a) capable of smoothing control are located in each of the areas. The rated power output of one PV system is 4 kW. Each of the areas A˜E have, respectively, 7500 houses (Total area power output of 30 MW), 2500 houses (Total area power output of 10 MW), 5000 houses (Total area power output of 20 MW), 2500 houses (Total area power output of 10 MW) and 7500 houses (Total area power output of 30 MW) located therein. Moreover, the weather was actually the midday of a Spring day with measured strong fluctuations in incident sunlight, and it was supposed that the weather would move to the adjacent area with a five minute delay.

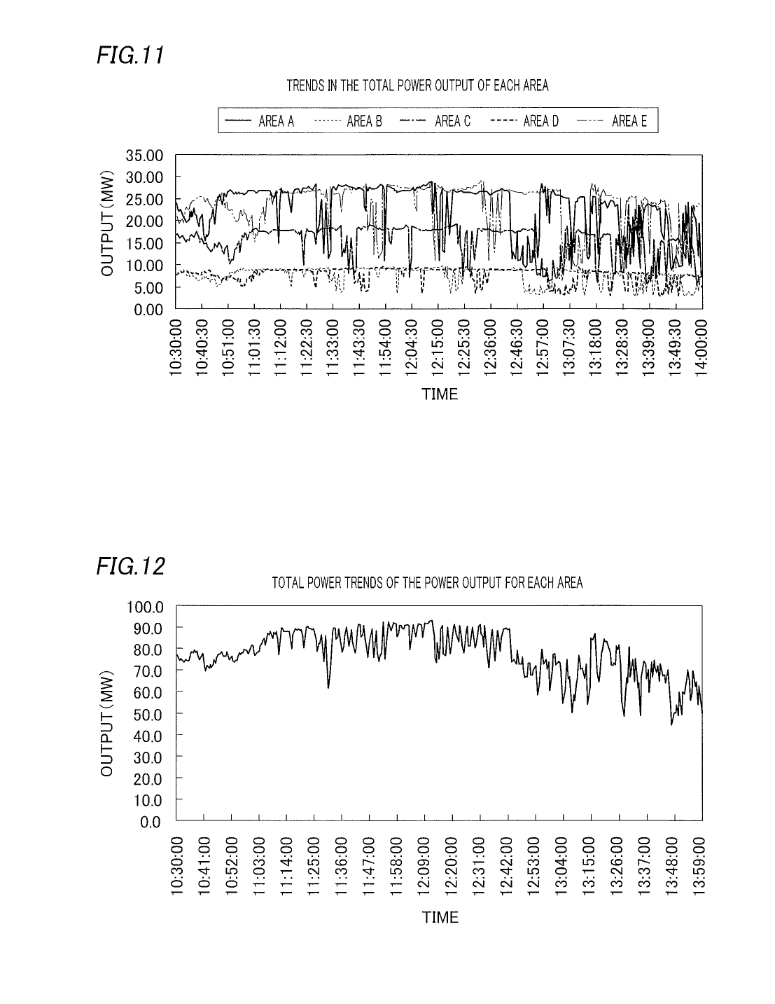

In this area and weather model, the trends in the power output were computed for each area. FIG. 11 shows the results of the computations. FIG. 12 shows the total power trends of the power output for each area. As shown in FIG. 11 and FIG. 12, in a comparison of the total power trends for each area, the fluctuation in the total power trends for the whole area are suppressed.

Next, in this area and weather model, as an embodiment, the need or otherwise for smoothing was determined based on the total power output of the total area shown in FIG. 12, and a simulation was performed wherein smoothing control was performed on each PV system. Moreover, as a comparative embodiment, a determination was reached on the need or otherwise for smoothing control for each area (In other words, a determination of the need for smoothing control on each of the PV systems), and a simulation was performed of performing smoothing control on each of the PV systems. Then in respect of each of the embodiment and the comparative example, the number of instances of charge and discharge of each of the PV systems in the area and the charge and discharge amount were computed. The Table 1 below shows these computed results. Now the number of instances of charge and discharge for the whole area (397 times) in the comparative embodiment is the mean value of the number of instances of charge and discharge in each of the area A˜E in the comparative embodiment (402 times, 404 times, 394 times, 379 times and 406 times). Moreover, the charge and discharge amount for the whole area in the embodiment (36195 kWh) is the total for that of each of the areas A˜E (11380 kWh, 3682 kWh, 7126 kWh, 3476 kWh and 10531 kWh). Also, the charge and discharge amount for the whole area in the comparative embodiment (41308 kWh) is the total for that of each of the areas A˜E (12930 kWh, 4255 kWh, 8194 kWh, 3918 kWh and 12011 kWh).

TABLE 1

| | | Number of times | | Amount of | |
|---|---|---|---|---|---|
| | | charged and | | the charge and | |
| | Power | discharged | | discharges (kWh) | |
| | Output | | Comparative | | Comparative |
| | (MW) | Embodiment | Embodiment | Embodiment | Embodiment |
| The | 100 | 340 | 397 | 36195 | 41308 |
| total | | | | | |
| area | | | | | |
| Area | 30 | 340 | 402 | 11380 | 12930 |
| A | | | | | |
| Area | 10 | 340 | 404 | 3682 | 4255 |
| B | | | | | |
| Area | 20 | 340 | 394 | 7126 | 8194 |
| C | | | | | |
| Area | 10 | 340 | 379 | 3476 | 3918 |
| D | | | | | |
| Area | 30 | 340 | 406 | 10531 | 12011 |
| E | | | | | |

As shown in Table 1, on comparison of the overall area, in the embodiment, there was at least a 10% reduction in the number of instances of charge and discharge, and the charge and discharge amount, compared to the comparative embodiment. Moreover, in a comparison of each of the areas A˜E for the embodiment there was at least a 10% reduction in the number of instances of charge and discharge, and the charge and discharge amount, compared to the comparative embodiment. This was because of the non-performance of smoothing in respect of the fluctuations as a result of the suppression by the run-in effect in the embodiment, with the result that the frequency of charging and discharging the battery could be reduced.

### Embodiment 2

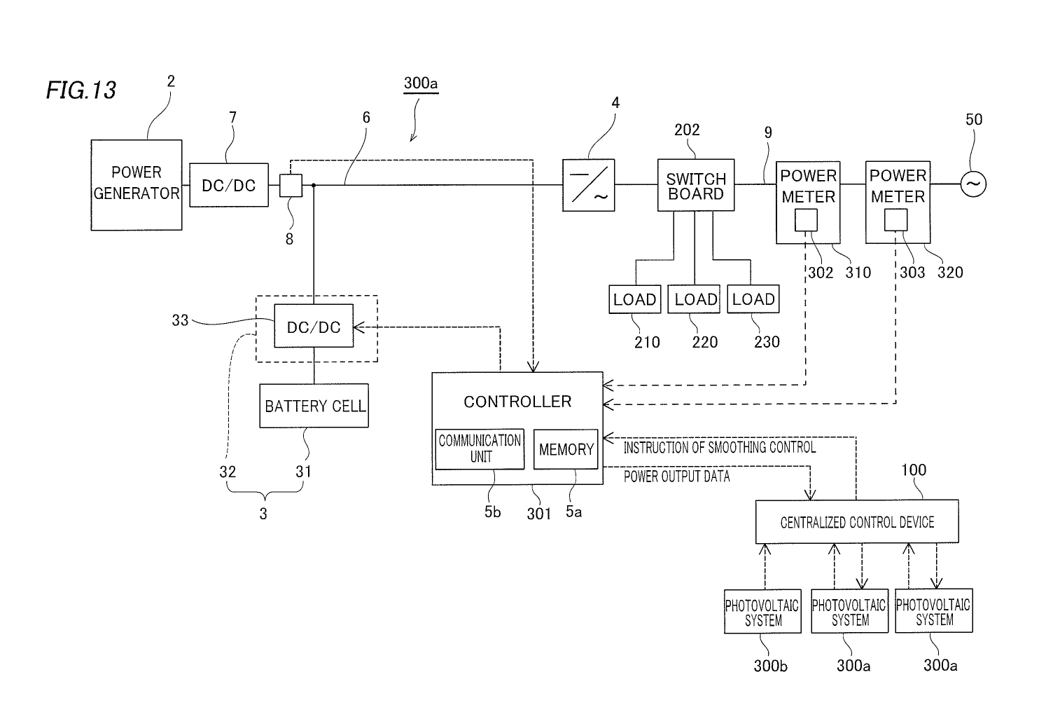

Next, the stabilization system of the second embodiment of this invention is explained while referring to FIG. 13. The first embodiment showed an example where the centralized control device 100 made a determination of whether smoothing control was required based on the power output of the entire area. On the other hand, in the second embodiment, an example is explained wherein a determination is made as to the necessity for smoothing control based on the input and output power (the power purchase or the power selling) for the PV systems 300a and 300b of the entire area and the power grid 50. Now, where the configuration elements have the same function as in the first embodiment, the same reference numerals are employed.

The stabilization system of this embodiment provides the PV systems 300a and 300b installed within a specific area, and the centralized control device 100 communicating with the PV systems 300a and 300b. The PV system 300a, as shown in FIG. 13, provides the power generator 2, and the battery 3, and the supply section 4, and the controller 301, and the DC-DC converter 7 and the detector 8, and has a smoothing control function. Moreover, the PV system 300b has the battery 3 removed from the configuration of the PV system 300a, and does not have a smoothing control function. The three loads 210, 220 and 230 are connected to the alternating current bus 9, via switchboard 202, between the supply section 4 and the power grid 50.

Moreover, the power meter 310 measuring the power sold to the power grid 50 from the PV systems 300a and 300b, and the power meter 320 measuring the power purchased from the power grid 50, are disposed on the power grid 50 side from the switchboard 202 of the bus 9. power sensor 302 and power sensor 303 are provided on the power meter 310 and the power meter 320, respectively. The power sensor 302 and the power sensor 303 detect the power data (the power purchase data and the power selling data) of the input and output power for the PV systems 300a and 300b and the power grid 50.

The controller 301 acquires the power purchase data or the power selling data for specific detection time intervals (e.g. less than 30 seconds) from power sensors 302 and 303. The controller 301 computes a detected power data. The detected power data is calculated by subtracting the power purchase data from the power selling. The controller 303 also computes the target output value based on past detected power data. Then, the controller 301 performs the charge and discharge of the battery cell 31 in order to compensate for the difference between the target output value and the actual detected power output. In other words, when the actual power output is greater than the target output value, the controller 301 controls the DC-DC converter 33 in order to charge the excess power to the battery cell 31, and when the actual power output is less than the target output value, the controller 301 controls the DC-DC converter 33 in order to discharge the shortfall in power from the battery cell 31.

Furthermore, the controller 301 transmits the detected power data to the centralized control device 100 on every detection instance. The centralized control device 100 determined whether or not to perform smoothing control based on the total area detected power data. Based on the determination result of the centralized control device 100, the controller 301 instructs the initiation and termination of smoothing control in respect of the PV system 300a.

The configuration of the second embodiment, other than that described above, is the same as that of embodiment 1.

In embodiment 2, because there are plural loads (Loads 210, 220 and 230) prepared, the fluctuation in the amount of the load in respect of the total load is great. Because of this, rather than computing the target output value based on the power output data detected from the detector 8, just as in the first embodiment, the computation of the target output value based on the detected power data detected by the power sensor 302 and the power sensor 303, enables the derivation of the effects of the load. By performing smoothing based on these values reflecting the load, the effective performance of the smoothing is enabled.

Now in the embodiments and example disclosed here, it should be considered that all points were for the purposes of illustration and the invention is not limited to those points. The scope of the present invention is not defined by those embodiments explained but by the scope of the claims of the invention, and in addition, all equivalent meaning to the scope of the claims and all modifications within the range of the scope of the claims are included in the invention.

In embodiments 1 and 2, examples were shown where lithium ion batteries or Ni-MH batteries were employed as the battery cells, but the present invention is not limited to these, and other rechargeable batteries may be employed.

Furthermore, in the embodiment 1 described above, an explanation was provided whereby the power consumption in the consumer home was not taken into consideration in the load in the consumer home, but this invention is not limited to this, and in the computation of the target output value, a power is detected wherein at least part of the load is consumed at the consumer location, and the computation of the target output value may be performed considering that load consumed power output or the fluctuation in the load consumed power output.

Moreover, in the embodiments 1 and 2 described above, examples were explained wherein the determination of the need or otherwise for smoothing control was based on the total power output computed from the detected power output or the generated power output, but the present invention is not limited to these, and determination of the need for smoothing control can be based on the total value of the measured values from measurement devices located at plural locations within the area detecting the amount of sunlight (Data on amount of incident sunlight).

Moreover, in embodiments 1 and 2, when the centralized control device 100 makes a determination as to whether to perform smoothing control, there was an explanation of an example where instructions were issued to all of the PV systems 1a within the area to perform smoothing control, but this invention is not limited to this, and the centralized control device 100 may issue instructions to only some of the PV systems 1a within the area to perform smoothing control. For example, the centralized control device 100 may issue instructions to only the PV systems 1a within the areas where the PV systems 1a are plentiful to perform smoothing control. By this means, the charge and discharge frequency of the batteries of the PV systems 1a of other areas may be further reduced.

Furthermore, in embodiments 1 and 2, an explanation was provided of an example where the centralized control device 100 makes a determination as to whether to perform smoothing control based on the total of the power output of all of the PV systems 1a and 1b in the area which the centralized control device 100 can communicate with, but this invention is not limited to this. The centralized control device 100 may make a determination as to whether to perform smoothing control based on the total of the power output of some of the PV systems 1a and 1b in the area. For example, the region may be divided in several areas, and the centralized control device 100 may make a determination as to whether to perform smoothing control based on the power output of a predetermined representative PV system. Moreover, in the event that the area is one where the cloud flow tends to be in a particular direction, the representative PV systems may preferably be chosen along a specific direction and at a specific distance apart at plural domain locations. Because the total power of the power output of the PV systems chosen in this way suppress the fluctuations by the run-in effect, a similar effect to the determination of the need for smoothing control or otherwise based on the total power output of all of the PV systems 1a and 1b may be enabled.

What is claimed is:

1. An electrical power supply system managed by a master management system external to the supply system, the supply system comprising:
a power generator configured to generate electric power using renewable energy;
a battery configured to store electric power generated by the power generator;
a power output device configured to output power from at least one of the power generator and the battery;
a charge and discharge controller configured to acquire generated power data from the power generator, to transmit the generated power data to the master management system, to compute a target output value for output from the power output device based on the generated power output data, and to control charge and discharge of the battery such that the target output value is outputted from the power output device, the charge and discharge controller being also configured to receive charge and discharge instruction signals from the master management device, and to initiate or terminate the charge and discharge of the battery based on the charge and discharge instruction signals.

2. The system of claim 1, wherein the charge and discharge control device is further configured to acquire the generated power data at a predetermined time interval from the power generator and to transmit the acquired generated power data to the master control device at each time interval.

3. A master control device which controls plural electrical power supply systems external to the control device, the master control device comprising:
a generated power data acquisition unit configured to acquire generated power data from each of the plural power supply systems;
a power computation unit configured to compute a total power output by summing the generated power data from the plural power supply systems;
a charge and discharge controller configured to determine whether the total power output exceeds a predetermined threshold value, to transmit charge and discharge instruction signals in accordance with determination results to the power supply systems.

4. The master control device of claim 3, wherein the charge and discharge controller is further configured to determine whether to terminate charge and discharge of the power supply systems, when the power supply systems are performing charging and discharging, and when it is determined that the total power output is less than the threshold value.

5. The master control device of claim 3, wherein the generated power acquisition unit is further configured to acquire the generated power at a predetermined time interval, the power output computation unit is further configured to compute an amount of fluctuation of the total power output at each interval, and the charge and discharge controller is further configured to determine whether the fluctuation amount of the total power output exceeds a predetermined threshold value, to transmit the charge and discharge instruction signal in order to initiate charge and discharge of the power supply systems.

6. The master control device of claims 3, wherein the plural power supply systems include systems that include batteries and systems that do not include batteries, and the charge and discharge controller is further configured to transmit the charge and discharge instruction signals to the power supply systems that include batteries.

7. The system stabilization systems including the power supply system of claim 1, and including the master control device of claims 3.

8. A method of controlling a master control device managing plural power supply systems external to the control device, the method comprising:
acquiring generated power output data from the plural power supply systems;
computing a total power output by summing the power output data from the plural power supply systems;
determining whether the total power output exceeds a predetermined threshold value;
transmitting charge and discharge instruction signals in accordance with the determination to the power supply systems.

9. The method of claim 8, further comprising acquiring the generated power output data at a predetermined time interval, computing an amount of fluctuation of the total power output at each interval, determining whether the fluctuation amount of the total power output exceeds a predetermined threshold fluctuation value, transmitting the charge and discharge instruction signals to the power supply systems in order to initiate charge and discharge of the battery when the fluctuation amount exceeds the fluctuation threshold value.

10. A computer-readable recording medium which records a control programs for causing one or more computers to perform the steps comprising:
acquiring generated power output data from plural power supply systems;
computing a total power output by summing the power output data from the plural power systems;
determining whether the total power output exceeds a predetermined threshold value; and
transmitting charge and discharge instruction signals in accordance with the determination to the power supply systems.

11. A computer-readable recording medium of claim 10, wherein the steps comprises acquiring the generated power output data at a predetermined time interval, computing an amount of fluctuation of the total power output at each interval, determining whether the fluctuation amount of the total power output exceeds a predetermined fluctuation threshold value, transmitting the charge and discharge instruction signals to the power supply systems in order to initiate charge and discharge of the battery when the fluctuation amount exceeds the fluctuation threshold value.

12. An electrical power supply system managed by a master management system external to the supply system, the supply system comprising:
a power generator configured to generate electric power using renewable energy;
a battery configured to store electric power generated by the power generator;
a detector configured to detect power output data which are amounts of power output flowing on a power line connecting the power generator and a power grid; and
a charge and discharge controller configured to communicate with the master management system, to compute a target output value for output to the power grid based on the detected power output data, and to control charging and discharging of the battery so as to output the target output value to the power grid from at least one of the power generator and the battery, the charge and discharge controller being further configured to receive charge and discharge instruction signals from the master management device and to initiate or terminate charge and discharge of the battery based on the charge and discharge instruction signals.
